(19) United States
(12) Patent Application Publication
(10) Pub. No.: US 2024/0429770 A1
(43) Pub. Date: Dec. 26, 2024

(54) ARMATURE AND ROTATING ELECTRICAL MACHINE

(71) Applicant: DENSO CORPORATION, Kariya-city (JP)

(72) Inventors: Ryo MITANI, Kariya-city (JP); Naoto NATSUME, Kariya-city (JP); Masayuki ECHIZEN, Kariya-city (JP)

(73) Assignee: DENSO CORPORATION, Kariya-city (JP)

(21) Appl. No.: 18/823,095

(22) Filed: Sep. 3, 2024

Related U.S. Application Data
(63) Continuation of application No. PCT/JP2022/046734, filed on Dec. 19, 2022.

(30) Foreign Application Priority Data
Mar. 1, 2022 (JP) 2022-031101

(51) Int. Cl. H02K 3/52

(52) U.S. Cl. CPC H02K 3/522

(57) ABSTRACT

A stator includes a stator core, an insulator, and a plurality of coils. The stator core is equipped with teeth which are arranged away from each other in a circumferential direction of the stator. The insulator is secured to the stator core. The coils are made of windings of conductive wires around the teeth. The stator also includes terminals (i.e., first terminals and a second terminal). The terminals include insulator retainers (i.e., first insulator retainers and a second insulator retainer) and crimps. The insulator retainers are secured to the insulator. Each of the crimps is disposed between two of the coils which are arranged adjacent to each other in the circumferential direction. Ends of the coils (i.e., first ends and second ends) are secured to the crimps.

### CROSS REFERENCE TO RELATED DOCUMENT

The present application claims the benefit of priority of Japanese Patent Application No. 2022-031101 filed on Mar. 1, 2022, the disclosure of which is incorporated in its entirety herein by reference.

### TECHNICAL FIELD

This disclosure relates generally to an armature and a rotating electrical machine.

### BACKGROUND ART

Japanese Patent First Publication No. 2020-99174 listed below teaches a rotating electrical machine implemented by an inner-rotor brushless motor. The rotating electrical machine includes a plurality of stator magnetic pole members on which coils are disposed and a plurality of conductive members. The conductive members are electrically connected to ends of the coils using a plurality of connectors. Each of the connectors is disposed between an adjacent two of the stator magnetic pole members, thereby enabling the size of the rotating electrical machine to be reduced in size in the axial direction thereof.

### PRIOR ART DOCUMENT

### Patent Literature

FIRST PATENT LITERATURE: Japanese Patent First Publication No. 2020-99174

### SUMMARY OF THE INVENTION

Generally, it is preferable for rotating electrical machines installed in a given space in vehicles, such as automobiles, to reduce the size of the rotating electrical machines in the axial direction thereof in the way described in the above publication.

It is an object of this disclosure to provide an armature and a rotating electrical machine which are capable of being reduced in size in an axial direction thereof.

According to one aspect of this disclosure, there is provided an armature which comprises: (a) a stator core which includes teeth arranged at an interval away from each other in a circumferential direction of the armature; (b) an insulator secured to the stator core; (c) a plurality of coils each of which is made of a winding of a conductive wire around a respective one of the teeth; and (d) a terminal which is made from electrically conductive material and includes an insulator retainer secured to the insulator and a crimp to which a coil end of the coils is secured and which is arranged between two of the coils which are located adjacent to each other in the circumferential direction.

The above structures enable the armature and the rotating electrical machine to have a size reduced in an axial direction thereof.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is a schematic view which illustrates a motor, as viewed in an axial direction thereof, according to the first embodiment;

FIG. 2 is a perspective view which illustrates a stator;

FIG. 3 is a plan view which illustrates a stator;

FIG. 4 is an enlarged plan view which illustrates a portion of a stator in which a first terminal is arranged;

FIG. 5 is an enlarged side view which illustrates a portion of a stator in which a first terminal is arranged, as viewed from radially inside the stator;

FIG. 6 is a perspective view which illustrates a first terminal;

FIG. 7 is a perspective view which illustrates a first terminal, as viewed in a direction different from that in FIG. 6;

FIG. 8 is a perspective view which illustrates a second terminal;

FIG. 9 is a side view which illustrates a second terminal, as viewed from radially inside an armature;

FIG. 10 is a side view which illustrates a second terminal according to the second embodiment, as viewed from radially inside an armature;

FIG. 11 is a plan view which shows a second terminal and a terminal coupling of a motor according to the third embodiment;

FIG. 12 is a side view which illustrates a second terminal of a motor in the third embodiment;

FIG. 13 is a cross-sectional side view, as taken along a line 13-13 in FIG. 11, which shows a terminal coupling and a second terminal;

FIG. 14 is a sectional view which illustrates a terminal, an insulator, and a stator core of a motor according to the fourth embodiment;

FIG. 15 is a sectional view which shows a terminal and an insulator of a motor according to the fifth embodiment; and

FIG. 16 is a sectional view which shows a terminal and an insulator of a motor according to the sixth embodiment.

### MODE FOR CARRYING OUT THE INVENTION

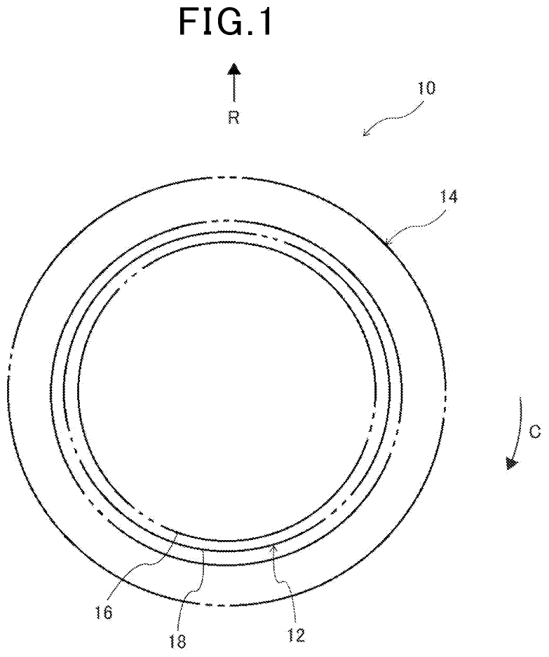

The electrical motor 10 according to the first embodiment will be described below with reference to FIGS. 1 to 9. In the drawings, arrows Z, R, and C indicate a first axial direction, a radially outward direction, and a first circumferential direction of the rotor 12, respectively, which will be referred to later in detail. In the following discussion, an axial direction, a radial direction, and a circumferential direction represent a direction in which a rotational axis of the rotor 12 extends, a direction perpendicular to a direction in which the rotor 12 rotates, and the direction in which the rotor 12 rotates, respectively, unless otherwise specified. The motor 10, as referred to in this disclosure, is an example of a rotating electrical machine.

The motor 10 is, as can be seen from FIG. 1, an inner-rotor brushless motor. The motor 10 includes the stator 14 working as an armature and the rotor 12 disposed radially inside the stator 14.

The rotor 12 includes the rotor core 16 secured to a rotational shaft, not shown, and magnets 18 attached to an outer peripheral surface of the rotor core 16. The magnets 18 are made of, for example, ring magnets. The magnets 18 are arranged adjacent to each other in the circumferential direction to have N-poles and S-poles which alternately appear on radial outsides of the magnets 18. The magnets 18 may alternatively be secured to an outer peripheral surface of the rotor core 16 to have the N-poles and S-poles which alternately appear on radial outsides of the magnets 18 in the circumferential direction.

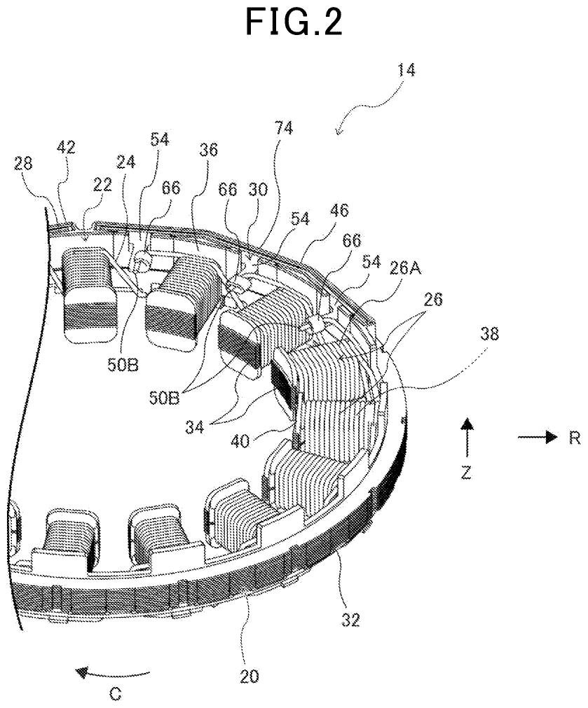

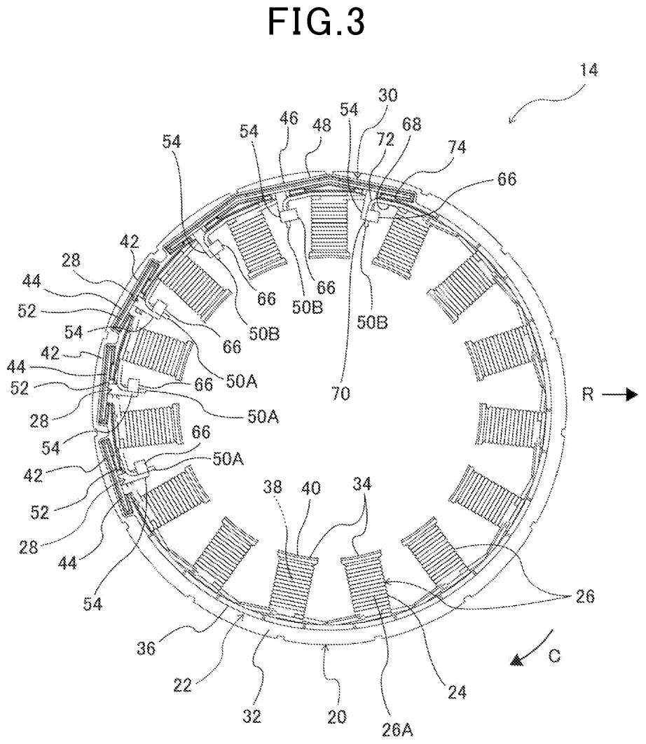

The stator 14, as shown in FIG. 2, includes the stator core 20, the insulator 22 secured to the stator core 20, and a plurality of coils 26 each of which is made of a winding of a conductor disposed on the stator core 20. The stator 14 is, as illustrated in FIGS. 2 and 3, equipped with three first terminals 28 and a single second terminal 30 to which ends of the coils 26 are electrically connected.

The stator core 20 is formed by steel plates which are made from soft magnetic material and stacked on one another in the axial direction. Each of the steel plates is produced by punching steel sheet into a desired shape. The stator core 20 includes the annular body 32 and the teeth 34 protruding radially inward from the annular body 32. The fifteen teeth 34 are, as clearly illustrated in FIG. 3, arranged at equal intervals away from each other in the circumferential direction.

The insulator 22 is made from an electrically insulating resin material and, as clearly illustrated in FIGS. 2 and 3, includes the annular cover 36 disposed to extend along an inner peripheral surface of the annular body 32 of the stator core 20.

The insulator 22 also includes the tooth covers 38 protruding radially inward from the annular cover 36. The tooth covers 38 are provided one for each of the teeth 34 of the stator core 20. Each of the tooth covers 38 covers an area of a corresponding one of the teeth 34 on which the coil 26 is arranged.

The insulator 22 also includes the flanges 40 each of which protrudes from a radially inner end of a corresponding one of the tooth covers 38 away from a corresponding one of the teeth 34 and extends in the axial direction. Each of the coils 26 is disposed around a corresponding one of the tooth covers 38 and located between the flange 40 and the annular cover 36. The insulator 22 in this embodiment is made of two sections separate from each other in the axial direction.

The insulator 22, as illustrated in FIG. 3, also includes three first terminal retainers 42 which support the first terminals 28 which will be described later in detail. The first terminal retainers 42 are arranged away from each other on one (which will also be referred to as a first end surface) of axially opposed end surfaces of the annular body 32 of the stator core 20 which faces in the first axial direction. Each of the first terminal retainers 42 has a first circumferential end and a second circumferential end opposed to the first circumferential end in the circumferential direction of the stator 14. The first circumferential end of each of the first terminal retainers 42 is located at the same position as that of a first one of a circumferentially adjacent two of the teeth 34 in the circumferential direction of the stator 14. The first one of the teeth 34 faces in the first circumferential direction of the stator 14. In other words, the first circumferential end of each of the first terminal retainers 42 is located in coincidence with the first one of the teeth 34 in the radial direction of the stator 14. Similarly, the second circumferential end of each of the first terminal retainers 42 is located at the same position as that of a second one of a circumferentially adjacent two of the teeth 34 in the circumferential direction of the stator 14. The second one of the teeth 34 faces in the second circumferential direction opposite the first circumferential direction of the stator 14. Each of the first terminal retainers 42 has a circumferential center aligned with a middle between a circumferentially adjacent two of the teeth 34 in the radial direction of the stator 14. In this embodiment, the three first terminal retainers 42 are circumferentially arranged in a region extending over four of the teeth 34 adjacent to each other in the circumferential direction. Each of the first terminal retainers 42 has formed therein the first terminal socket 44 working as a terminal coupling in the form of a fitting recess. Each of the first terminal sockets 44 is of a concave shape with an opening facing in the first axial direction.

The insulator 22 also includes the second terminal retainer 46 which holds the second terminal 30. The second terminal retainer 46 is disposed on the first end surface of the annular body 32 of the stator core 20. The second terminal retainer 46 extends over a region where four of the teeth 34 are arranged adjacent to each other in the circumferential direction. The second terminal retainer 46 is located on a first circumferential side of a circumferentially outermost one of the first terminal retainers 42 which faces in the first circumferential direction of the stator 14. In other words, the second terminal retainer 46 is arranged circumferentially adjacent to the circumferentially outermost one of the first terminal retainers 42. The second terminal retainer 46 has formed therein the second terminal socket 48 working as a terminal coupling. The second terminal socket 48 is of a concave shape with an opening facing in the first axial direction. The structure of the second terminal socket 48 will also be described below in detail.

Each of the coils 26 is made by winding the copper wire 24 around a corresponding one of the teeth 34 of the stator core 20 through the insulator 22. In this embodiment, the coils 26 includes five U-phase coils 26, five V-phase coils 26, and five W-phase coils 26 which are disposed around the teeth 34. The U-phase coils 26, the V-phase coils 26, and the W-phase coils 26 are arranged in this order in the circumferential direction. The U-phase coils 26, the V-phase coils 26, and the W-phase coils 26 are connected in series with each other.

The wire 24 which forms the five U-phase coils 26 has two ends: the first U-phase end 50A and the second U-phase end 50B.

Similarly, the wire 24 which forms the five V-phase coils 26 has two ends: the first V-phase end 50A and the second V-phase end 50B.

Similarly, the wire 24 which forms the five W-phase coils 26 has two ends: the first W-phase end 50A and the second W-phase end 50B.

The first U-phase end 50A, the first V-phase end 50A, and the first W-phase end 50A are, as illustrated in FIGS. 3, 4, and 5, connected to the first terminals 28, respectively. The second U-phase end 50B, the second V-phase end 50B, and the second W-phase end 50B are connected to the second terminal 30.

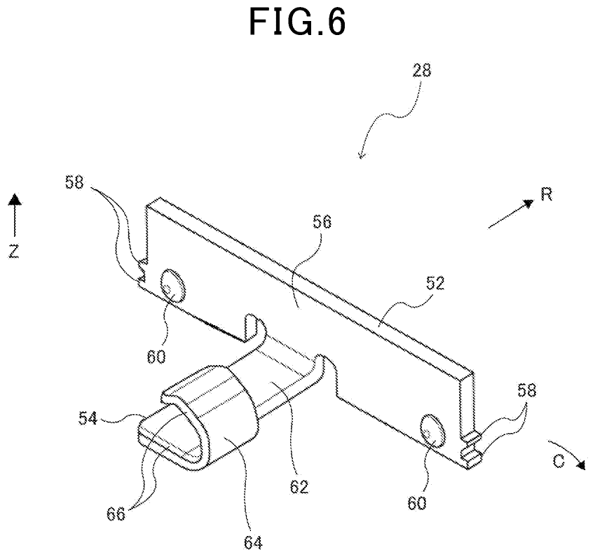

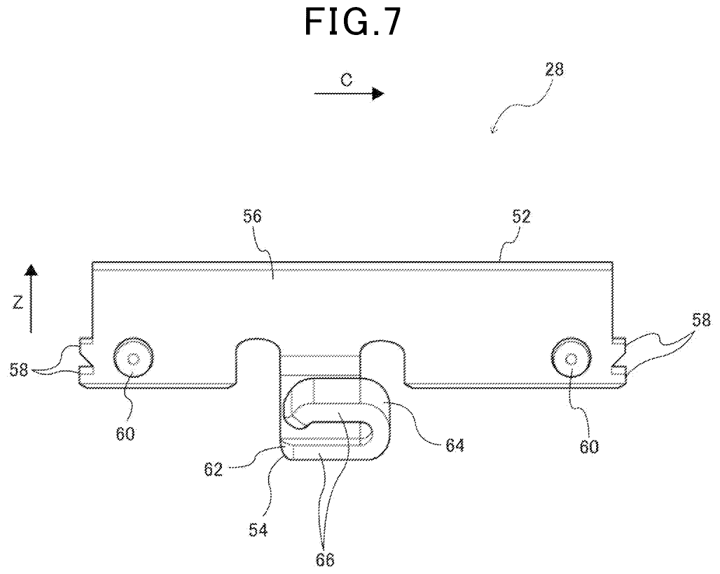

Each of the first terminals 28 is, as clearly illustrated in FIGS. 6 and 7, made by pressing a copper plate into a desired shape. Each of the first terminals 28 includes the first insulator retainer 52 which is of a rectangular shape with a thickness in the radial direction and serves as an insulator holder. Each of the first terminals 28 also includes the crimp strip 54 which extends radially inward from a portion of the first insulator retainer 52 which is located both at the circumferential center thereof and at one of axially opposed side surfaces which faces in the second axial direction of the stator 14 (i.e., the rotor 12).

The first insulator retainer 52 includes the rectangular base 56 having a length extending in the circumferential direction and a width in the axial direction. The first insulator retainer 52 also includes a plurality of (two in this embodiment) press-fit protrusions 58 which are formed on a first end of the base 56 which faces in the first circumferential direction and extend from a portion of the first end which is located close to the second side surface of the first insulator retainer 52 which faces in the second axial direction. The first insulator retainer 52 also includes a plurality of (two in this embodiment) press-fit protrusions 58 which are formed on a second end the base 56 which faces in the second circumferential direction and extend from a portion of the second end which is located close to the second side surface of the first insulator retainer 52 which faces in the second axial direction. Each of the press-fit protrusions 58 is of a saw-tooth shape, as viewed in the radial direction. The first insulator retainer 52 also has the backlash-filling protrusions 60 which are formed on circumferentially opposed end portions of the base 56 and located close to the second side surface of the first insulator retainer 52. The backlash-filling protrusions 60 protrude radially inward.

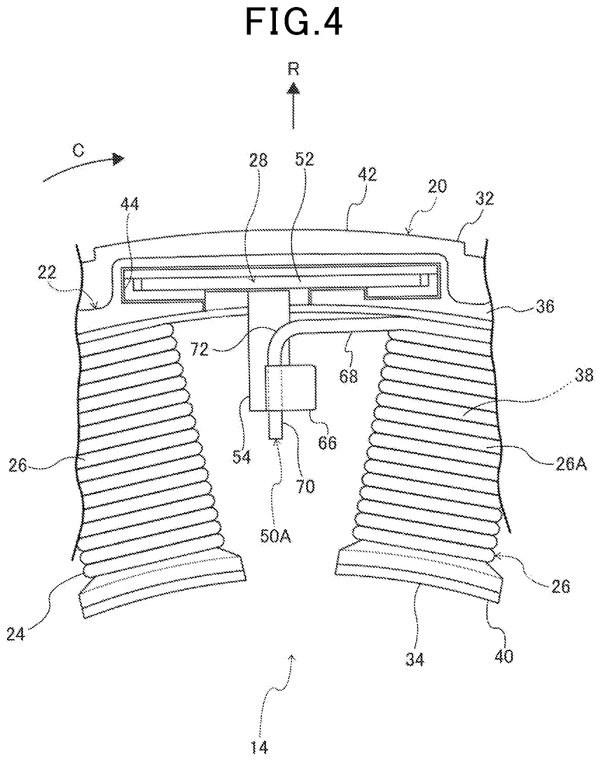

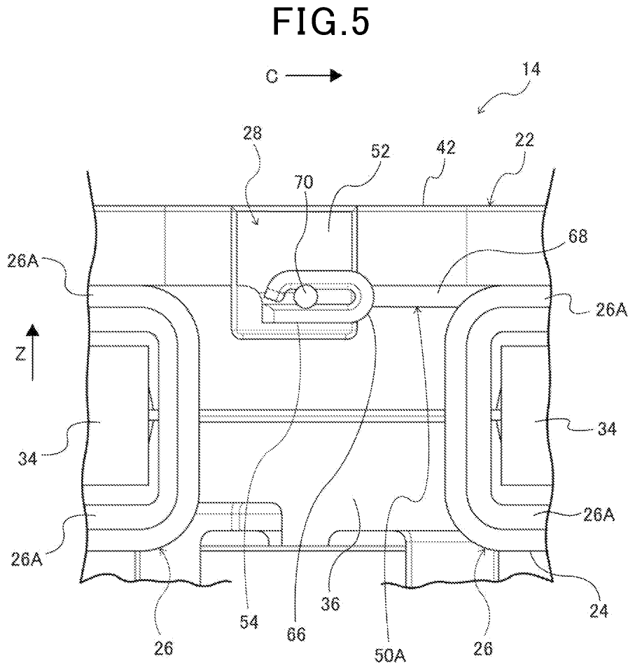

The crimp strip 54 includes the rectangular base 62 having a length in the radial direction and a width in the circumferential direction. The crimp strip 54 also includes the extension 64 which extends from a radially inner end portion of the base 62 in the first circumferential direction and has an end portion which is separate from the base 62 and curved or bent in the second circumferential direction. The extension 64 defines the crimp barrel 66 along with the radially inner end portion of the base 62. The crimp barrel 66 works as a crimp to create electrical connection and has an opening facing in the second circumferential direction. The above-described first end 50A is, as illustrated in FIGS. 4 and 5, firmly gripped by the crimp barrel 66 to achieve a joint of the first end 50A with the crimp barrel 66.

The first insulator retainer 52 of each of the first terminals 28 is, as can be seen in FIG. 4, inserted into the first terminal socket 44 of the insulator 22, thereby securing the first insulator retainer 52 to the insulator 22 to hold the first terminal 28 in the insulator 22. The first insulator retainer 52 which has been forced into the first terminal socket 44 has the press-fit protrusions 58 firmly fit on the inner wall of the first terminal socket 44, thereby ensuring the stability in retaining the first insulator retainer 52 in the insulator 22. When the first insulator retainer 52 is retained in the insulator 22, the press-fit protrusions 58 on the first end of the first insulator retainer 52 which face in the first circumferential direction are, as can be seen from FIGS. 4, 6, and 7, located circumferentially at the same position as that of one of a circumferentially adjacent two of the teeth 34 which is arranged close to the first end of the first insulator retainer 52, in other words, aligned with the one of the teeth 34 in the radial direction of the stator 14. Similarly, the press-fit protrusions 58 on the second end of the first insulator retainer 52 which face in the second circumferential direction are located at the same position as that of one of a circumferentially adjacent two of the teeth 34 which is arranged close to the second end of the first insulator retainer 52, in other words, aligned with the one of the teeth 34 in the radial direction of the stator 14. When the first insulator retainer 52 is fit in the insulator 22, the crimp strip 54 is, as can be seen in FIGS. 4 and 5, located at the center between a circumferentially adjacent two of the teeth 34. The base 62 of the crimp strip 54 is, as clearly illustrated in FIGS. 5 and 6, disposed between the coil ends 26A (which will also be referred to as the first coil ends 26A) of a circumferentially adjacent two of the coils 26 which face in the first axial direction Z.

Each of the first ends 50A, as can be seen in FIG. 4, has the first section 68 which extends in the second circumferential direction from a radially outer end of one of the coil ends 26A which faces in the first axial direction. The first end 50A also has the second section 70 which extends radially inward (i.e., away from the annular body 2 of the stator core 20) from an end of the first section 68 which faces in the second circumferential direction. The first end 50A also has the flexible section 72 defining a boundary between the first section 68 and the second section 70. The flexible section 72 defines the first section 68 and the second section 70 into an L-shape. The second section 70 of the first end 50A is joined to the crimp barrel 66 of the first terminal 28. The first section 68 may alternatively be designed to extend from in the second circumferential direction from a radially inner end of one of the coil ends 26A which faces in the first axial direction, it is advisable that the second section 70 be oriented to extend radially outward (i.e., toward the annular body 2 of the stator core 20) from an end of the first section 68 which faces in the second circumferential direction. The flexible section 72 may be shaped to be moderately curved.

The second section 70 of the first end 50A which is joined to the crimp barrel 66 of the first terminal 28 is, as can be seen in FIGS. 4 and 5, laid along the first major surface of the base 62 of the crimp strip 54 which faces in the first axial direction Z. The first section 68, the second section 70, and the flexible section 72 of the first end 50A between the first coil ends 26A of a circumferentially adjacent two of the coils 26 which face in the first axial direction Z.

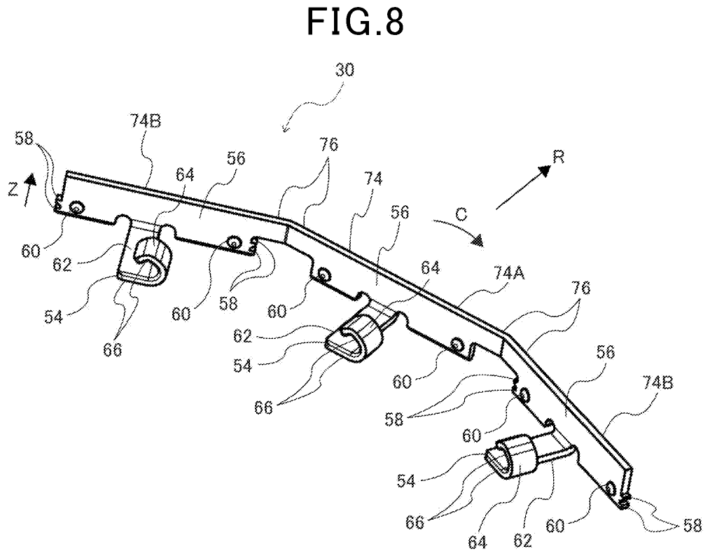

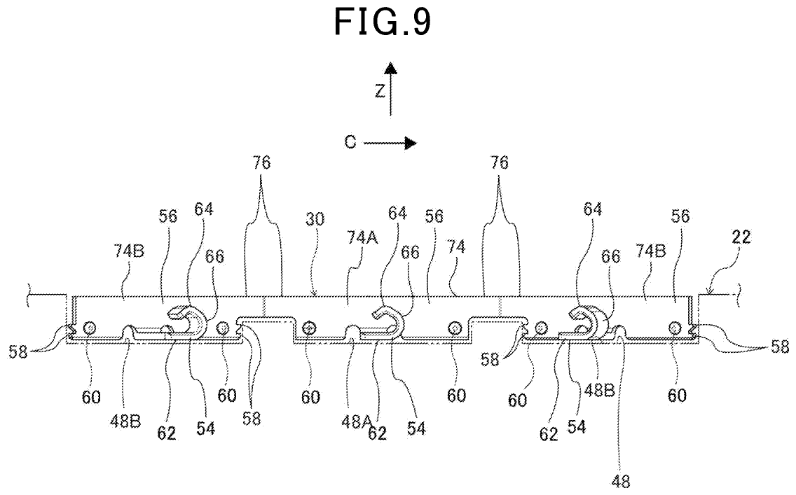

The second terminal 30 is, as can be seen in FIGS. 8 and 9, similar to the first terminals 28, made by pressing a copper conductive plate into a desired shape. The second terminal 30 includes the second insulator retainer 74 which has a thickness in the radial direction and a length in the circumferential direction of the stator 14.

The second insulator retainer 74 has the central securing portion 74A that is defined by a circumferential central portion thereof. The second insulator retainer 74 also has the end securing portions 74B that are defined by end portions thereof facing in the first and second circumferential directions. In the following discussion, one of the end securing portions 74B which faces in the first circumferential direction will also be referred to as the first end securing portion 74B, while the other facing in the second circumferential direction will also be referred to as the second end securing portion 74B.

The central securing portion 74A is identical in structure with the first terminals 28 of the first insulator retainer 52 (see FIG. 6) except that the central securing portion 74A has no press-fit protrusions 58, but includes the connecting tabs 76 extending both from ends of the length thereof which face in the first and second circumferential directions. The connecting tabs 76 are located close to the first side surface of the central securing portion 74A which faces in the first axial direction.

The first end securing portion 74B facing in the first circumferential direction is identical in structure with the first terminals 28 of the first insulator retainer 52 (see FIG. 6) except that the connecting tab 76 extends from a second end of the first end securing portion 74B which faces in the second circumferential direction and is disposed closer to the first side surface of the first end securing portion 74B facing in the first axial direction. The connecting tab 76 of the first end securing portion 74B leads to one of the connecting tabs 76 of the central securing portion 74A which faces in the first circumferential direction.

The second end securing portion 74B facing in the second circumferential direction is identical in structure with the first terminals 28 of the first insulator retainer 52 (see FIG. 6) except that the connecting tab 76 extends from a first end of the second end securing portion 74B which faces in the first circumferential direction and is disposed closer to the first side surface of the first end securing portion 74B facing in the first axial direction. The connecting tab 76 of the second end securing portion 74B leads to one of the connecting tabs 76 of the central securing portion 74A which faces in the second circumferential direction.

Parts of the central securing portion 74A and the end securing sections 74B which are identical with those of the first insulator retainer 52 of each of the first terminals 28 are denoted by the same reference numbers as those in the first insulator retainer 52.

The second terminal 30 also includes three crimp strips 54 extending radially inward from second side surfaces of the central securing portion 74A, the first end securing portion 74B, and the second end securing portion 74B which face in the second axial direction. The crimp strips 54 are arranged at equal interval away from each other in the circumferential direction. Each of the crimp strips 54 of the second terminal 30 is identical in structure with that of the first terminals 28. The same parts of the crimp strips of the second terminal 30 as those of the first terminals 28 are denoted by the same reference numbers. The above-described second ends 50B are, as illustrated in FIG. 3, held by the crimp barrels 66 of the crimp strips 54 to electrically connect the second ends 50B to the crimp barrels 66 of the crimp strips 54.

The second insulator retainer 74 of the second terminal 30 is, as illustrated in FIGS. 3 and 9, fit in the second terminal socket 48 of the insulator 22. The second terminal socket 48, as can be seen in FIG. 9, has the central fit recess 48A which is formed in a circumferentially central portion of the bottom of the second terminal socket 48 and in which a second side portion of the central securing portion 74A which faces in the second axial direction is fit. The second terminal socket 48 also has the side fit recess 48B (which will also be referred to as the first side fit recess 48B) which is formed in a first circumferential side portion of the bottom of the second terminal socket 48 facing in the first circumferential direction and in which a second side portion of the first end securing portion 74B which faces in the second axial direction is fit. The second terminal socket 48 also has the side fit recess 48B (which will also be referred to as the second side fit recess 48B) which is formed in a second circumferential side portion of the bottom of the second terminal socket 48 facing in the second circumferential direction and in which a second side portion of the second end securing portion 74B which faces in the second axial direction is fit. When the second insulator retainer 74 of the second terminal 30 is fit in the second terminal socket 48 of the insulator 22, the second side portion of the central securing portion 74A which faces in the second axial direction is fit in the central fit recess 48A. Simultaneously, the second side portion of the first and second end securing portions 74B which face in the second axial direction are also fit in the side fit recesses 48B. This secures the second insulator retainer 74 to the insulator 22, so that the second terminal 30 is retained by the insulator 22. When the second side portions of the first and second end securing portions 74B are fit in the side fit recesses 48B, the press-fit protrusions 58 are press-fit on the inner walls of the side fit recesses 48B, thereby ensuring the stability in holding the second insulator retainer 74 by the insulator 22. The press-fit protrusions 58 of the second terminal 30 are, like those of the first terminals 28, located at the same positions as the selected teeth 34 in the circumferential direction. Each of the three crimp strips 54 of the second terminal 30 is, as can be seen in FIG. 3, located at the center between a circumferentially adjacent two of the teeth 34.

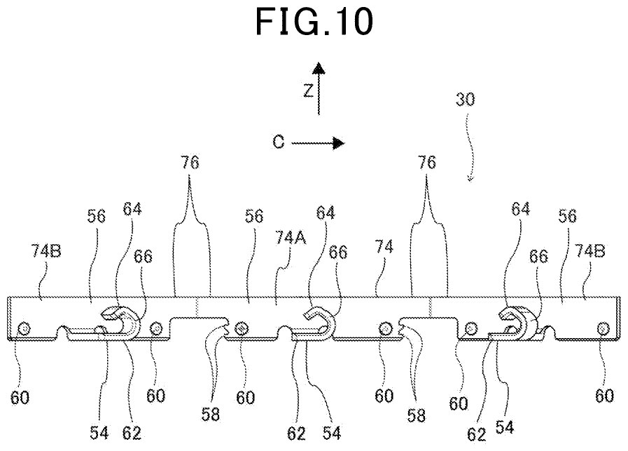

As apparent from the above discussion, the second terminal 30 has the plurality of press-fit protrusions 58 formed only on the first and second end securing portions 74B, in other words, has no press-fit protrusions 58 on the central securing portion 74A, but however, the central securing portion 74 of the second terminal 30 may alternatively be designed, like the second embodiment illustrated in FIG. 10, to has the press-fit protrusions 58 formed thereon. In this structure, the first and second end securing portions 74B may have no press-fit protrusions 58.

The second ends 50B are, as can be seen from FIG. 3, identical in structure with the first ends 50A. The same parts of the second ends 50B as those of the first ends 50A are denoted by the same reference numbers. The second section 70 of each of the U-phase, V-phase, and W-phase second ends 50B is joined to a corresponding one of the crimp barrels 66 of the second terminal 30.

### Operation of this Embodiment and Beneficial Advantages Offered Thereby

The operation of this embodiment and beneficial advantages offered thereby will be described below.

The motor 10 in this embodiment is, as can be seen in FIGS. 1 to 3, operated by switching application of voltage among the first terminals 28 to change a flow of electrical current among the U-phase, V-phase, and W-phase coils 26, thereby creating a rotating magnetic field around the stator 14 to rotate the rotor 12.

The motor 10 in this embodiment is, as can be seen in FIGS. 2 to 5, designed to have the crimp barrels 66 of the first terminals 28 and the crimp barrel 66 of the second terminal 30 each of which is arranged between a circumferentially adjacent two of the teeth 34 (i.e., the coils 26). This layout of the crimp barrels 66 enables the stator 14 to be reduced in size in the axial direction as compared with when the crimp barrels 66 of the first terminals 28 and the crimp barrel 66 of the second terminal 30 are located on one of axially opposed ends of the stator core 20.

When the first insulator retainers 52 of the first terminals 28 are fit in the first terminal sockets 44 of the insulator 22, the press-fit protrusions 58 of the first insulator retainers 52 are, as can be seen in FIGS. 3, 4, 6, 7, 8, and 9, press-fit on the inner walls of the first terminal sockets 44, thereby minimizing misalignment of the first terminals 28 with the insulator 22 which usually arises from mechanical vibration of the motor 10. This improves or ensures the reliability in operation of the motor 10 against the mechanical vibration. Particularly, the plurality of press-fit protrusions 58 arranged on circumferentially opposed sides of each of the crimp strips 54 serve to reduce mechanical vibration of the crimp strips 54.

When the second insulator retainer 74 of the second terminal 30 is fit in the second terminal socket 48 of the insulator 22, the press-fit protrusions 58 are press-fit on the inner wall of the side fit recess 48B, thereby minimizing misalignment of the second terminal 30 with the insulator 22 which usually rises from mechanical vibration of the motor 10. This ensures or improves the reliability in operation of the motor 10 against the mechanical vibration. The second terminal 30 has the plurality of press-fit protrusions 58 formed only on the first and second end securing portions 74B, in other words, has no press-fit protrusions 58 on the central securing portion 74A, thereby minimizing mechanical vibration of the circumferentially opposed ends of the second terminal 30 more than the central portion of the second terminal 30. The second terminal 30 of the motor in the second embodiment illustrated in FIG. 10 has the press-fit protrusions 58 formed on the central securing portion 74A and no press-fit protrusions 58 formed on the first and second end securing portions 74B. This layout of the press-fit protrusions 58 serves to minimize the mechanical vibration of the circumferentially central portion of the second terminal 30. The determination of which of the structures of the second terminal 30 of the motor 10 in the first embodiment or in the second embodiment should be employed depends on the frequency of vibration of the motor 10 and the natural frequency of vibration of the second terminal 30. The second terminal 30 may alternatively be designed to have the press-fit protrusions 58 on the central securing portion 74A in addition to the press-fit protrusions 58 formed on the first and second end securing portions 74B.

Each of the press-fit protrusions 58 of the first terminals 28 and the second terminal 30 is located in alignment with a corresponding one of the teeth 34 of the stator core 20 in the radial direction of the stator 14. In other words, each of Each of the press-fit protrusions 58 of the first terminals 28 and the second terminal 30 lies near a highly rigid portion of the stator core 20, thereby avoiding an undesirable rise in amplitude of vibration transmitted from the stator core 20 to the press-fit protrusions 58.

The coils 26 in this embodiment have the first ends 50A and the second ends 50B each of which, as illustrated in FIGS. 3, 4, and 5, includes the first section 68, the second section 70, and the flexible section 72. The flexible section 72 works to minimize tension appearing at a corresponding one of the first ends 50A or the second ends 50B, thereby decreasing stress occurring in a joint of one of the coils 26 and a corresponding one of the first terminals 28 or the second terminal 30, which minimizes a risk of disconnection in the first ends 50A or the second ends 50B of the coils 26.

Each of the first ends 50A and the second ends 50B is designed to have the second section 70 which is, as illustrated in FIGS. 3 to 5, arranged to extend on a surface of the base 62 of the crimp strip 54 which faces in the first axial direction, thereby causing the base 62 of the crimp strip 54 to minimize a shift of the second section 70 in the second axial direction which arises from mechanical vibration of the motor 10 in the axial direction of the motor 10. This reduces torsional deformation of the first section 68 arising from a shift of the second section 70 in the axial direction of the motor 10.

Each of the first ends 50A and the second ends 50B has the first section 68, the second section 70, and the flexible section 72 which are arranged between the first coil ends 26A of a circumferentially adjacent two of the coils 26. The first coil ends 26A face in the first axial direction. The above layout of the first section 68, the second section 70, and the flexible section 72 enables the first ends 50A or the second ends 50B to have a decreased length.

### Structures of Motors in Other Modes

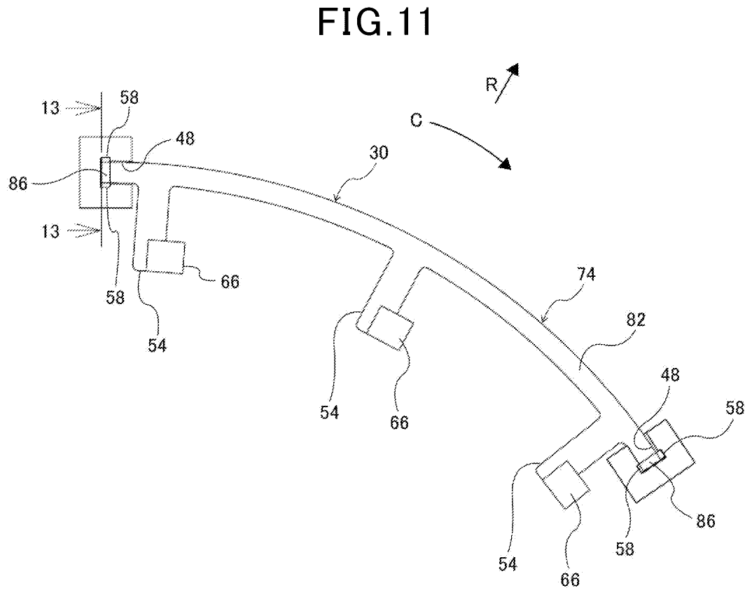

FIGS. 11 to 16 illustrate other modes of electrical motors 10. In FIGS. 11 to 16, the same reference numbers as employed in the first embodiment will refer to the same parts, and explanation thereof in detail will be omitted here.

### Motor in Third Embodiment

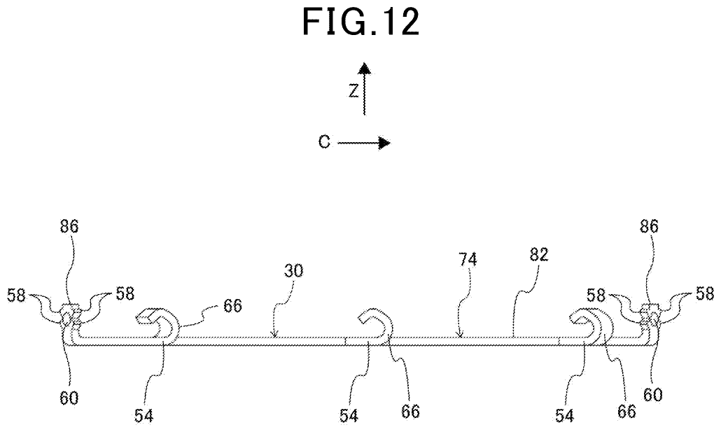

FIG. 11 illustrates the second terminal 30 and the second terminal socket 48 of the motor 10 in the third embodiment. The second insulator retainer 74 of the second terminal 30, as illustrated in FIGS. 11 and 12, includes the base 82 and a pair of fastening ends 86. The base 82 is made of a plate with a thickness in the axial direction and extends in the circumferential direction. The fastening ends 86 are bent from circumferentially opposed ends of the base 82 and extend in the first axial direction. Each of the fastening ends 86 has a plurality of press-fit protrusions 58 formed on radial outer and inner side surfaces thereof.

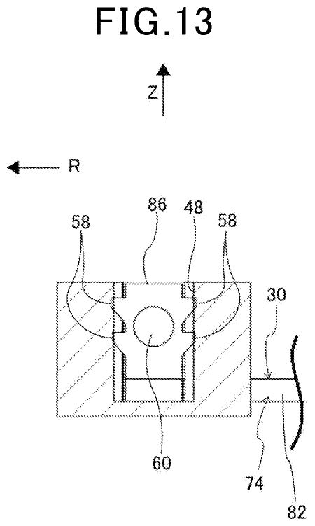

The insulator 22, as illustrated in FIGS. 11 and 13, also includes a pair of second terminal sockets 48 in which circumferentially opposed ends of the second insulator retainer 74 of the second terminal 30 (i.e., the fastening ends 86 and their peripheral portions) are fit. The fit of the ends of the second insulator retainer 74 of the second terminal 30 in the second terminal socket 48 provides retention of the second terminal 30 in the insulator 22.

The above-described structure in the third embodiment enables the size of a major part of the second insulator retainer 74 to be reduced in the axial direction as compared with the second terminal 30 of the motor 10 in the first embodiment.

### Motor in Fourth Embodiment

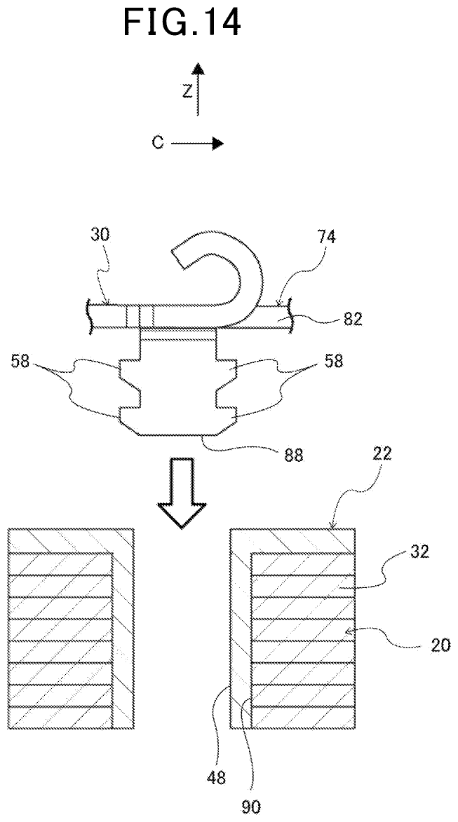

FIG. 14 is a sectional view which illustrates the second terminal 30, the insulator 22, and the stator core 20 of the motor 10 in the fourth embodiment. The second insulator retainer 74 of the second terminal 30 includes the base 82 and the barb fittings 88. The base 82 is made of a plate which has a thickness in the axial direction and extends in the circumferential direction. Each of the barb fittings 88 is bent from a radially outer end of the base 82 and extends in the second axial direction. Each of the barb fittings 88 and a corresponding one of the crimp strips 54 are located at the same position in the circumferential direction. Each of the barb fittings 88 has a plurality of press-fit protrusions 58 formed on circumferentially opposed ends thereof.

The annular body 32 of the stator 14 has formed therein the fitting holes 90 each of which has an opening facing in the first axial direction. The insulator 22 also includes the second terminal sockets 48 each of which is disposed on an inner peripheral surface of a corresponding one of the fitting holes 90 of the stator core 20. The barbe fittings 88 of the second insulator retainer 74 of the second terminal 30 are fit in the second terminal sockets 48, thereby firmly retaining the second terminal 30 in the insulator 22.

As apparent from the above discussion, the barb fittings 88 are, as can be seen in FIG. 14, inserted into the second terminal sockets 48 to force the barb fittings 88 into the fitting holes 90 of the stator core 20. This structure enables the stator 14 to be reduced in size in the axial direction of the stator 14 as compared with when the barb fittings 88 are designed to protrude outside the stator core 20 in the first axial direction.

### Motor in the Fifth Embodiment

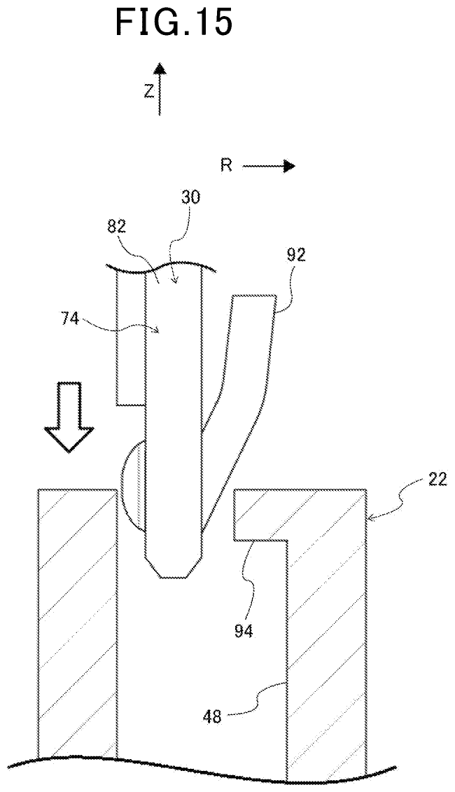

FIG. 15 is a sectional view which illustrates the second terminal 30 and the insulator 22 of the motor 10 according to the fifth embodiment. The second insulator retainer 74 of the second terminal 30 includes the base 82 and the snap-fit fasteners 92. The base 82 is made of a plate which has a thickness in the radial direction and extends in the circumferential direction. The snap-fit fasteners 92 protrude radially outside the base 82. Each of the snap-fit fasteners 92 is made by cutting and bending a portion of the base 82 in a radially outward direction of the stator 14.

The insulator 22 in this embodiment has the second terminal sockets 48 formed therein each of which has an opening facing in the second axial direction. The insulator 22 has the fittings 94 each of which protrudes radially inward from a radially outer portion of a corresponding one of the second terminal sockets 48. Insertion of the second insulator retainer 74 of the second terminal 30 into the second terminal sockets 48 of the insulator 22 causes the snap-fit fasteners 92 to contact the fittings 94 so that the snap-fit fasteners 92 are elastically deformed toward the base 82. After completion of the insertion of the second insulator retainer 74 into the second terminal sockets 48, the snap-fit fasteners 92 are returned back to the initial position, so that the snap-fit fasteners 92 are placed to face the fittings 94 in the axial direction of the stator 14. This ensures the stability of joining the second insulator retainer 74 with the second terminal socket 48.

As apparent from the above discussion, the structure of this embodiment minimizes a risk that the second insulator retainer 74 may be removed undesirably from the second terminal sockets 48 without having to use the press-fit protrusions 58 (see FIG. 13).

### Motor in the Sixth Embodiment

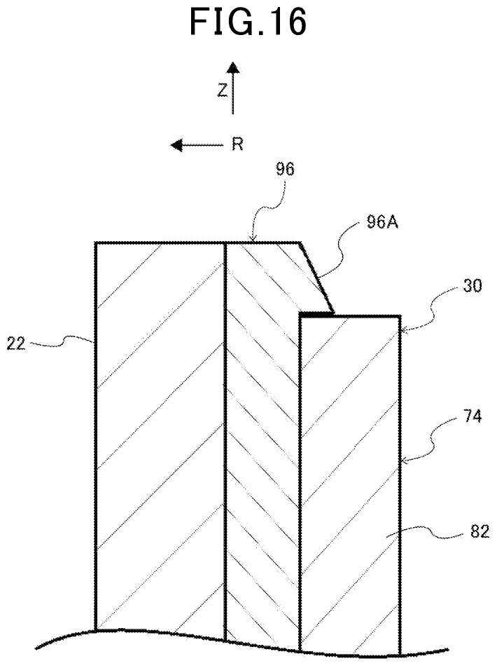

FIG. 16 is a sectional view which illustrates the second terminal 30 and the insulator 22 of the motor 10 according to the sixth embodiment. The second insulator retainer 74 of the second terminal 30 includes the base 82 made of a plate which has a thickness in the radial direction and extends in the circumferential direction.

The insulator 22 in this embodiment has the stake member 96 which is made from an iron-based material and insert-moulded therein. The base 82 of the second insulator retainer 74 of the second terminal 30 is placed along the staking member 96. The stake member 96 is then partially staked to produce the deformed portion 96A which is pressed against the base 82 of the second insulator retainer 74, thereby securing the second insulator retainer 74.

As apparent from the above discussion, the structure of the sixth embodiment achieves a firm joint of the second insulator retainer 74 of the second terminal 30 to the insulator 22 without use of the press-fit protrusions 58 (see FIG. 13).

This disclosure is not limited to the above embodiments and modifications, but may be realized by various embodiments without departing from the purpose of the disclosure. For instance, the structure of the motor 10 may be used for an electrical generator. The structure of the motor 10 may be employed in an outer-rotor brushless motor in which the rotor 12 is arranged radially outside the stator 14. The structure in this disclosure may also be used in a rotor equipped with an armature identical in structure with the stator 14.

This disclosure has referred to the above embodiments, but may be realized by various embodiments and equivalents without departing from the purpose of the disclosure. This disclosure includes all possible combinations of the features of the above embodiments and the modifications or features similar to the parts of the above embodiments and the modifications.

1-7. (canceled)

8. An armature comprising:
a stator core which includes teeth arranged at intervals away from each other in a circumferential direction of the armature;
an insulator secured to the stator core;
a plurality of coils each of which is made of a winding of a conductive wire around a respective one of the teeth; and
a terminal which is made from electrically conductive material and includes an insulator retainer secured to the insulator and a crimp to which a coil end of the coils is secured and which is arranged between two of the coils which are located adjacent to each other in the circumferential direction.

9. The armature as set forth in claim 8, wherein the insulator has formed therein a terminal coupling to which the insulator retainer is coupled, and
the insulator retainer has portions shaped as press-fit portions which is press-fit in the terminal coupling.

10. The armature as set forth in claim 9, wherein each of the press-fit portions is located in alignment with one of the teeth in a radial direction of the armature.

11. The armature as set forth in claim 9, wherein the insulator retainer has a crimp strip extending therefrom, the crimp strip including the crimp, and
the press-fit portions are located at portions of the insulator retainer which are arranged at circumferentially opposed sides of the crimp strip.

12. The armature as set forth in claim 9, wherein the insulator retainer has extending therefrom a plurality of crimp strips which include crimps, the crimp strips being arranged at an interval away from each other in the circumferential direction, and
the press-fit portions include first press-fit portions and second press-fit portions, the first press-fit portions being located at portions of the insulator retainer which are arranged at circumferentially opposed sides of an outermost one of the crimp strips which faces in a first circumferential direction of the armature, the second press-fit portions being located at portions of the insulator retainer which are arranged on circumferentially opposed sides of an outermost one of the crimp strips which faces in a second circumferential direction of the armature which is opposite the first circumferential direction.

13. The armature as set forth in claim 9, wherein the insulator retainer has extending therefrom a plurality of crimp strips which include crimps, the crimp strips being arranged at an interval away from each other in the circumferential direction, and
the press-fit portions are located at portions of the insulator retainer which are arranged on circumferentially opposed sides of a circumferentially central one of the crimp strips.

14. A rotating electrical machine comprising:
a first one of a stator and a rotor which includes the armature as set forth in claim 8; and
a second one of the stator and the rotor which includes a magnet radially facing the armature.

15. The armature as set forth in claim 10, wherein the insulator retainer has a crimp strip extending therefrom, the crimp strip including the crimp, and
the press-fit portions are located at portions of the insulator retainer which are arranged at circumferentially opposed sides of the crimp strip.

16. The armature as set forth in claim 10, wherein the insulator retainer has extending therefrom a plurality of crimp strips which include crimps, the crimp strips being arranged at an interval away from each other in the circumferential direction, and
the press-fit portions include first press-fit portions and second press-fit portions, the first press-fit portions being located at portions of the insulator retainer which are arranged at circumferentially opposed sides of an outermost one of the crimp strips which faces in a first circumferential direction of the armature, the second press-fit portions being located at portions of the insulator retainer which are arranged on circumferentially opposed sides of an outermost one of the crimp strips which faces in a second circumferential direction of the armature which is opposite the first circumferential direction.

17. The armature as set forth in claim 10, wherein the insulator retainer has extending therefrom a plurality of crimp strips which include crimps, the crimp strips being arranged at an interval away from each other in the circumferential direction, and
the press-fit portions are located at portions of the insulator retainer which are arranged on circumferentially opposed sides of a circumferentially central one of the crimp strips.

18. A rotating electrical machine comprising:
a first one of a stator and a rotor which includes the armature as set forth in claim 9; and
a second one of the stator and the rotor which includes a magnet radially facing the armature.

19. A rotating electrical machine comprising:
a first one of a stator and a rotor which includes the armature as set forth in claim 10; and
a second one of the stator and the rotor which includes a magnet radially facing the armature.

20. A rotating electrical machine comprising:
a first one of a stator and a rotor which includes the armature as set forth in claim 11; and
a second one of the stator and the rotor which includes a magnet radially facing the armature.

21. A rotating electrical machine comprising:
a first one of a stator and a rotor which includes the armature as set forth in claim 15; and
a second one of the stator and the rotor which includes a magnet radially facing the armature.

22. A rotating electrical machine comprising:
a first one of a stator and a rotor which includes the armature as set forth in claim 12; and
a second one of the stator and the rotor which includes a magnet radially facing the armature.

23. A rotating electrical machine comprising:
a first one of a stator and a rotor which includes the armature as set forth in claim 16; and
a second one of the stator and the rotor which includes a magnet radially facing the armature.

24. A rotating electrical machine comprising:
a first one of a stator and a rotor which includes the armature as set forth in claim 13; and
a second one of the stator and the rotor which includes a magnet radially facing the armature.

25. A rotating electrical machine comprising:
a first one of a stator and a rotor which includes the armature as set forth in claim 17; and
a second one of the stator and the rotor which includes a magnet radially facing the armature.
